(19) United States
(12) Patent Application Publication
(10) Pub. No.: US 2019/0353928 A1
(43) Pub. Date: Nov. 21, 2019

(54) FRONTAL COMMUNICATION BETWEEN OPHTHALMIC LENSES USING ULTRASOUND

(71) Applicant: Johnson & Johnson Vision Care, Inc., Jacksonville, FL (US)

(72) Inventors: Donald Scott Langford, Melbourne Beach, FL (US); Adam Toner, Jacksonville, FL (US)

(21) Appl. No.: 15/982,026

(22) Filed: May 17, 2018

(51) Int. Cl. G02C 7/04; G02C 7/02; G06F 3/01; B06B 1/02; H04B 11/00

(52) U.S. Cl. CPC G02C 7/049; G02C 7/027; G06F 3/013; B06B 2201/20; H04B 11/00; B06B 2201/76; B06B 1/0215

(57) ABSTRACT

A pair of ophthalmic lens having an electronic system is described herein for communicating between them using ultrasound transducers for creating a sound pressure wave(s) to be scattered by the nose of the wearer of the ophthalmic lenses. The ophthalmic lenses include at least one ultrasound module having at least one transducer such as a pair of transmit and receive transducers, a transceiver transducer or a plurality of transducers. The ultrasound module includes additional components for the creation and reception of the sound pressure wave(s). In at least one embodiment, the sound pressure wave(s) encodes a message between the contact lenses. In at least one embodiment, the ophthalmic lenses include contact lenses or intraocular lenses.

### BACKGROUND OF THE INVENTION

### 1. Field of the Invention

The present invention relates to a powered or electronic ophthalmic lens, and more particularly, to a powered or electronic ophthalmic lens having an ultrasound module to provide a communication link across the nose of the wearer.

### 2. Discussion of the Related Art

As electronic devices continue to be miniaturized, it is becoming increasingly more likely to create wearable or embeddable microelectronic devices for a variety of uses. Such uses may include monitoring aspects of body chemistry, administering controlled dosages of medications or therapeutic agents via various mechanisms, including automatically, in response to measurements, or in response to external control signals, and augmenting the performance of organs or tissues. Examples of such devices include glucose infusion pumps, pacemakers, defibrillators, ventricular assist devices and neurostimulators. A new, particularly useful field of application is in ophthalmic wearable lenses and contact lenses. For example, a wearable lens may incorporate a lens assembly having an electronically adjustable focus to augment or enhance performance of the eye. In another example, either with or without adjustable focus, a wearable contact lens may incorporate electronic sensors to detect concentrations of particular chemicals in the precorneal (tear) film. The use of embedded electronics in a lens assembly introduces a potential requirement for communication with the electronics, for a method of powering and/or re-energizing the electronics, for interconnecting the electronics, for internal and external sensing and/or monitoring, and for control of the electronics and the overall function of the lens.

The human eye has the ability to discern millions of colors, adjust easily to shifting light conditions, and transmit signals or information to the brain at a rate exceeding that of a high-speed internet connection. Lenses, such as contact lenses and intraocular lenses, currently are utilized to correct vision defects such as myopia (nearsightedness), hyperopia (farsightedness), presbyopia and astigmatism. However, properly designed lenses incorporating additional components may be utilized to enhance vision as well as to correct vision defects.

Conventional contact lenses are polymeric structures with specific shapes to correct various vision problems as briefly set forth above. To achieve enhanced functionality, various circuits and components have to be integrated into these polymeric structures. For example, control circuits, microprocessors, communication devices, power supplies, sensors, actuators, light-emitting diodes, and miniature antennas may be integrated into contact lenses via custom-built optoelectronic components to not only correct vision, but to enhance vision as well as provide additional functionality as is explained herein. Electronic and/or powered ophthalmic lenses may be designed to provide enhanced vision via zoom-in and zoom-out capabilities, or just simply modifying the refractive capabilities of the lenses. Electronic and/or powered contact lenses may also be designed to enhance color and resolution.

The proper combination of devices could yield potentially unlimited functionality; however, there are a number of difficulties associated with the incorporation of extra components on a piece of optical-grade polymer. In general, it is difficult to manufacture such components directly on the lens for a number of reasons, as well as mounting and interconnecting planar devices on a non-planar surface. It is also difficult to manufacture to scale. The components to be placed on or in the lens need to be miniaturized and integrated onto just 1.5 square centimeters of a transparent polymer while protecting the components from the liquid environment on the eye. It is also difficult to make a contact lens comfortable and safe for the wearer with the added thickness of additional components.

In addition, because of the complexity of the functionality associated with a powered lens and the high level of interaction between all of the components comprising a powered lens, there is a need to coordinate and control the overall operation of the electronics and optics comprising a powered ophthalmic lens. Accordingly, there is a need for a system to control the operation of all of the other components and provide communication between the contact lenses that is safe, low-cost, and reliable, has a low rate of power consumption and is scalable for incorporation into an ophthalmic lens. Accordingly, there exists a need for a means and method for communicating between ophthalmic lenses while they are being worn and/or with an external device.

There are several scenarios where there is a need for powered contact lenses to communicate with each other during normal operation. Methods of detecting and changing lens state for presbyopia, commonly referred to as accommodation, may require the state of the left and right eye to be shared to determine if the lens focus should be changed. In each case, the independent state of each eye must be communicated so that the system controller can determine the required state of the variable lens actuator. There are other cases where it may enhance the user experience if the lens state (e.g., focus state) is changed in a coordinated fashion.

### SUMMARY OF THE INVENTION

Lens-to-lens communication may take place wirelessly. There are at least three approaches to communicate lens-to-lens: photonic (light), radio frequency (RF) and ultrasound communication. Communication using light is difficult as the power consumption associated with generating photonic signals sufficiently powerful to overcome ambient interference may be prohibitive for the lens power source. RF signal generation may be possible but challenging. Higher RF frequency signals are required to operate with antennas that are sized to fit within a typical contact lens application. Generation of higher frequency signals typically require more power due to less efficient sources. In addition, RF energy is absorbed by human tissue thus reducing power at the receiver. Ultrasound communication is desirable as the sound spectrum is unregulated and there are few background ultrasound signals. The required ultrasound frequency is orders of magnitude lower than required RF frequency for a similar application. The power level required to generate ultrasound signals is therefore lower than RF signals for a similar application. Ultrasound energy has significantly less absorption in the human body. Due to the lower absorption, the allowed power levels for safe ultrasound energy operation in the body are orders of magnitude higher than RF energy limits.

In at least one embodiment, an ophthalmic lens (including an intraocular lens or contact lens) system includes: a first ophthalmic lens; a second ophthalmic lens; and wherein each ophthalmic lens including at least one ultrasound module in the ophthalmic lens, at least one of the at least one ultrasound module includes at least one transducer front-facing and orientated such that when a sound pressure wave is produced, the sound pressure wave travels outwardly from the ophthalmic lens, a system controller in electrical communication with the at least one ultrasound module, the system controller configured to provide a control signal to the at least one ultrasound module where the control signal includes a message to be transmitted by the at least one ultrasound module, the system controller configured to receive an output from the at least one ultrasound module and to perform a function in response to a receive message embodied in the output, and a timing circuit in electrical communication with the system controller, the timing circuit configured to produce a timing signal when the system controller is activated. In a further embodiment, each ophthalmic lens includes a plurality of ultrasound modules evenly distributed around the perimeter of the ophthalmic lens. Further to the previous embodiment, on each lens, the system controller configured to activate the ultrasound module that produces the strongest output in response to a sound pressure wave produced by the other ophthalmic lens, and the system controller configured to deactivate the at least one other ultrasound module on the ophthalmic lens.

Further to the above embodiments, the ultrasound module may take a variety of forms and the below described transmit and receive paths may be combined in a variety of ways other than discussed in this paragraph. In one embodiment, the at least one transducer includes a transmit transducer and a receive transducer, and each ultrasound module includes a processor in electrical communication with the system controller; a transmit path having an oscillator in electrical communication with the processor, a burst generator in electrical communication with the oscillator and the processor, a transmit driver in electrical communication with the burst generator configured to receive a burst signal from the burst generator, the transmit transducer in electrical communication with the transmit driver; and at least one receive path having the receive transducer, a receive amplifier in electrical communication with the receive transducer and configured to amplify an output of the receive transducer, and an analog signal processor in communication with the receive amplifier and the processor, and wherein the processor configured to control whether the transmit path and the at least one receive path are activated. Further to the previous embodiment, each ultrasound module includes two receive paths, the two receive paths having the receive transducer tuned to different frequencies. In another embodiment, the at least one transducer is one transducer, and each ultrasound module includes a processor in electrical communication with the system controller; the transducer; a switch in electrical communication with the processor; a transmit path having an oscillator in electrical communication with the processor, a burst generator in electrical communication with the oscillator and the processor, a transmit driver in electrical communication with the burst generator configured to receive a burst signal from the burst generator, the transmit driver drives the transducer when connected through the switch; and at least one receive path having a receive amplifier in electrical communication with the transducer through the switch and configured to amplify an output of the transducer, and an analog signal processor in communication with the receive amplifier and the processor, and wherein the processor configured to control whether the transmit path and the at least one receive path are activated based on an operation mode of the ultrasound module between transmit and receive, and the processor configured to control the switch and the operation mode. In another embodiment, each ophthalmic lens includes a power source in electrical communication with the system controller and the at least one ultrasound module; the at least one transducer includes a transmit transducer and a receive transducer; and each ultrasound module includes a processor in electrical communication with the system controller; a transmit path having an oscillator in electrical communication with the processor, a pulse generator in electrical communication with the oscillator and the processor, a charge pump in electrical communication with the power source, a transmit driver in electrical communication with the pulse generator and the charge pump, the transmit driver configured to receive a signal from the pulse generator, the transmit transducer in electrical communication with the transmit driver; and at least one receive path having the receive transducer, a receive amplifier in electrical communication with the receive transducer and configured to amplify an output of the receive transducer, and an envelope detector in electrical communication with the receive amplifier, an analog signal processor in communication with the envelope detector and the processor, and wherein the processor configured to control whether the transmit path and the at least one receive path are activated. In a still further embodiment, each ophthalmic lens includes a power source in electrical communication with the system controller and the at least one ultrasound module; the at least one transducer includes a transmit transducer and a receive transducer, and each ultrasound module includes a processor in electrical communication with the system controller; a transmit path having an oscillator in electrical communication with the processor, an amplitude modulation modulator in electrical communication with the oscillator and the processor, a charge pump in electrical communication with the power source, a transmit driver in electrical communication with the amplitude modulation modulator and the charge pump, the transmit driver configured to receive a signal from the amplitude modulation modulator, the transmit transducer in electrical communication with the transmit driver; and at least one receive path having the receive transducer, a receive amplifier in electrical communication with the receive transducer and configured to amplify an output of the receive transducer, and an envelope detector in electrical communication with the receive amplifier, an analog signal processor in communication with the envelope detector and the processor, and wherein the processor configured to control whether the transmit path and the at least one receive path are activated. In another embodiment, the at least one transducer includes a plurality of transducers, and the ultrasound module includes a processor in electrical communication with the system controller; a multiplexer in electrical communication with the plurality of transducers; a transmit path having an oscillator in electrical communication with the processor, a burst generator in electrical communication with the oscillator and the processor, a transmit driver in electrical communication with the burst generator configured to receive a burst signal from the burst generator and the multiplexer; and at least one receive path having a receive amplifier in electrical communication with the multiplexer and configured to amplify an output of the receive transducer, and an analog signal processor in communication with the receive amplifier and the processor, and wherein the processor configured to control whether the transmit path and the at least one receive path are activated, and the multiplexer provides selective communication between at least one transducer with the transmit path or the at least one receive path.

In a further embodiment to any of the above embodiments, the at least one ultrasound module on the first ophthalmic lens is configured to produce the sound pressure wave at a first frequency, and the at least one ultrasound module on the second ophthalmic lens is configured to produce the sound pressure wave at a second frequency, the at least one ultrasound module on the second ophthalmic lens has a receive transducer tuned to sense the sound pressure wave at the first frequency, and the at least one ultrasound module on the first ophthalmic lens has a receive transducer tuned to sense the sound pressure wave at the second frequency. Further to the previous embodiment, the at least one ultrasound module on the first ophthalmic lens has a second receive transducer tuned to sense the sound pressure wave at the first frequency, and the at least one ultrasound module on the second ophthalmic lens has a second receive transducer tuned to sense the sound pressure wave at the second frequency. In a further embodiment to any of the above embodiments, the message being sent is in a burst signal having a unique identification for the ophthalmic lens transmitting the message.

In a further embodiment to any of the above embodiments, the at least one transducer is angled relative to an imaginary plane taken at a bottom edge of the ophthalmic lens on which the at least one transducer is located.

In at least one embodiment, a method for facilitating communication between a first ophthalmic lens and a second ophthalmic lens when being worn by a person where each ophthalmic lens includes at least one ultrasound module in electrical communication with a system controller, the ultrasound modules having a forward facing transmit transducer, the method including: sending a control signal from the system controller on the first ophthalmic lens to the ultrasound module on the first ophthalmic lens where the control signal embodies a message intended for the second ophthalmic lens; preparing an output signal by the ultrasound module on the first ophthalmic lens based on the message; driving the transmit transducer on the first ophthalmic lens based on the output signal to produce at least one sound pressure wave; receiving with a transducer on the second ophthalmic lens at least one partially scattered sound pressure wave from the transducer on the first ophthalmic lens; converting with the ultrasound module on the second ophthalmic lens an analog signal produced by the transducer on the second ophthalmic lens in response to the received sound pressure wave; providing an output to the system controller on the second ophthalmic lens from the ultrasound module on the second ophthalmic lens; and converting with the system controller on the second ophthalmic lens the output into the message from the system controller on the first ophthalmic lens, and wherein a nose of the person wearing the ophthalmic lenses scatters the sound pressure wave produced by the first ophthalmic lens. In a further embodiment, the method further including: sending a control signal from the system controller on the second ophthalmic lens to the ultrasound module on the second ophthalmic lens where the control signal embodies a message intended for the first ophthalmic lens; preparing an output signal by the ultrasound module on the second ophthalmic lens based on the message intended for the first ophthalmic lens; driving the transmit transducer on the second ophthalmic lens based on the output signal to produce at least one sound pressure wave; receiving with a receive transducer on the first ophthalmic lens at least one partially scattered sound pressure wave from the transmit transducer on the second ophthalmic lens; converting with the ultrasound module on the first ophthalmic lens an analog signal produced by the receive transducer on the first ophthalmic lens; providing an output to the system controller on the first ophthalmic lens from the ultrasound module on the first ophthalmic lens; and converting with the system controller on the first ophthalmic lens the output into the message from the system controller on the first ophthalmic lens, and wherein a nose of the person wearing the ophthalmic lenses scatters the sound pressure wave produced by the second ophthalmic lens. Further to the previous embodiments, the sound pressure waves produced by the first and second ophthalmic lens are at different frequencies. Further to any of the above embodiments, each ultrasound module includes the transducer tuned to the frequency of the output transducer of the other ophthalmic lens and a second receive transducer tuned to the frequency of the output transducer of its ophthalmic lens.

Further to any of the above method embodiments, each ophthalmic lens includes a plurality of ultrasound modules evenly distributed around the periphery of the ophthalmic lens; and the method further including: selecting by the at least one system controller the ultrasound module on its ophthalmic lens that produces a highest output in response to the sound pressure wave produced by the other ophthalmic lens, and deactivating by the at least one system controller the non-selected ultrasound modules. Further to any of the above method embodiments, the method further including deactivating the transmission components of the ultrasound module when not transmitting.

Further to the previous embodiments, the ophthalmic lens includes an intraocular lens and/or a contact lens.

Further to any of the embodiments above, a message sent by the system controller of the first ophthalmic lens uses a predefined protocol. Further to any of the embodiments above, the message sent by the system controller of the first ophthalmic lens includes instructions for the second ophthalmic lens to perform a predefined function. Further to any of the embodiments above, the message sent by the system controller of the first ophthalmic lens includes sensor readings from at least one sensor on the first ophthalmic lens.

### BRIEF DESCRIPTION OF THE DRAWINGS

The foregoing and other features and advantages of the invention will be apparent from the following, more particular description of preferred embodiments of the invention, as illustrated in the accompanying drawings.

FIG. 1 illustrates a contact lens having at least one ultrasound module in accordance with at least one embodiment of the present invention.

FIG. 2 illustrates a contact lens having at least one ultrasound module and a system controller having a register in accordance with at least one embodiment of the present invention.

FIG. 3 illustrates a contact lens having at least one ultrasound module and a timing circuit in accordance with at least one embodiment of the present invention.

FIG. 4 illustrates an ultrasound module in accordance with at least one embodiment of the present invention.

FIG. 5 illustrates an ultrasound module with one transducer and a multiplexer in accordance with at least one embodiment of the present invention.

FIG. 6 illustrates an ultrasound module with two receive transducers in accordance with at least one embodiment of the present invention.

FIG. 7 illustrates an ultrasound module with a charge pump and an envelope detector in accordance with at least one embodiment of the present invention.

FIG. 8 illustrates an ultrasound module with one transducer and a multiplexer in accordance with at least one embodiment of the present invention.

FIG. 9 illustrates an ultrasound module with one transducer and a multiplexer in accordance with at least one embodiment of the present invention.

FIG. 10 illustrates a diagrammatic representation of an electronic insert, including a pair of transducers, for a powered contact lens in accordance with at least one embodiment of the present invention.

FIG. 11 illustrates a diagrammatic representation of an electronic insert, including a transducer, for a powered contact lens in accordance with at least one embodiment of the present invention.

FIG. 12 illustrates a diagrammatic representation of evenly spaced ultrasound modules/transducers in accordance with at least one embodiment of the present invention.

FIG. 13 illustrates an ultrasound module with a plurality of transmit/receive transducer pairs or transceiver transducers in accordance with at least one embodiment of the present invention.

FIG. 14 illustrates a communication method for two contact lenses in accordance with at least one embodiment of the present invention.

FIG. 15 illustrates a communication method for two contact lenses in accordance with at least one embodiment of the present invention.

### DETAILED DESCRIPTION OF THE EMBODIMENTS

Conventional contact lenses are polymeric structures with specific shapes to correct various vision problems as briefly set forth above. To achieve enhanced functionality, various circuits and components may be integrated into these polymeric structures. For example, control circuits, microprocessors, communication devices, power supplies, sensors, ultrasound modules, and miniature antennas may be integrated into contact lenses via custom-built optoelectronic components to not only correct vision, but to enhance vision as well as provide additional functionality as is explained herein. Electronic and/or powered contact lenses may be designed to provide enhanced vision via zoom-in and zoom-out capabilities, or just simply modifying the refractive capabilities of the lenses. Electronic and/or powered contact lenses may be designed to enhance color and resolution. In addition, ultrasound modules built into the lenses may be utilized to detect blink patterns and/or objects along with communicate with other lenses or external devices.

The powered or electronic contact lens in at least one embodiment includes the necessary elements to monitor the wearer with or without elements to correct and/or enhance the vision of the wearer with one or more of the above described vision defects or otherwise perform a useful ophthalmic function. The electronic contact lens may have a variable-focus optic lens, an assembled front optic embedded into a contact lens or just simply embedding electronics without a lens for any suitable functionality. The electronic lens of the present invention may be incorporated into any number of contact lenses as described above. In addition, intraocular lenses may also incorporate the various components and functionality described herein. However, for ease of explanation, the disclosure will focus on an electronic contact lens intended for single-use daily disposability.

The present invention may be employed in a powered ophthalmic lens or powered contact lens having an electronic system, which actuates a variable-focus optic or any other device or devices configured to implement any number of numerous functions that may be performed. An ophthalmic lens includes a contact lens and an intraocular lens. The electronic system includes one or more batteries or other power sources, power management circuitry, one or more sensors, clock generation circuitry, control algorithms and circuitry, and lens driver circuitry. The complexity of these components may vary depending on the required or desired functionality of the lens.

Control of an electronic or a powered ophthalmic lens may be accomplished through a manually operated external device that communicates with the lens through ultrasonic communication, such as a hand-held remote unit, a phone, a storage container, spectacles or a cleaning box. For example, an external device may wirelessly communicate using ultrasound with the powered lens based upon manual input from the wearer. Alternatively, control of the powered ophthalmic lens may be accomplished via feedback or control signals directly from the wearer. For example, ultrasound modules built into the lens may detect blinks, blink patterns, eyelid closures, and/or eye movement depending upon the configuration of the ultrasound modules, which in at least one embodiment include a transmit ultrasound transducer and at least one receive ultrasound transducer, a combination transmit/receive ultrasound transducer, or a combination passive transmit/receive backscatter ultrasound transducer. Based upon the pattern or sequence of blinks and/or movement, the powered ophthalmic lens may change operation state such as change focus of the contact lens. A further alternative is that the wearer has no control over operation of the powered ophthalmic lens.

Because of the complexity of the functionality associated with a powered lens and the high level of interaction between all of the components comprising a powered lens, there is a need to coordinate and control the overall operation of the electronics and optics comprising a powered ophthalmic lens. Accordingly, there is a need for a system to control the operation of all of the other components and provide communication between the contact lenses that is low-cost and reliable, has a low rate of power consumption, and is scalable for incorporation into an ophthalmic lens.

In at least one embodiment, a sound pressure wave which is produced at the transmit ultrasound transducer propagates from the contact lens into the field of view to provide communication between the contact lenses. In at least one embodiment, the sound pressure wave includes a burst or multiple sound pressure waves. Objects in the field of view will reflect and/or scatter the sound pressure wave. There is a finite amount of time that passes between the generation of the transmitted sound pressure wave and the return of the reflected signal. This time is determined by the speed of sound in air (typically 343 meters/second) and two times the distance to the object. Two times the distance to the object is used to account for the initial time it takes the sound pressure wave to travel from the transmit ultrasound transducer to the object and the time it takes the reflected wave to travel back to the receive ultrasound transducer. In at least one embodiment, the sound pressure wave is used for communication.

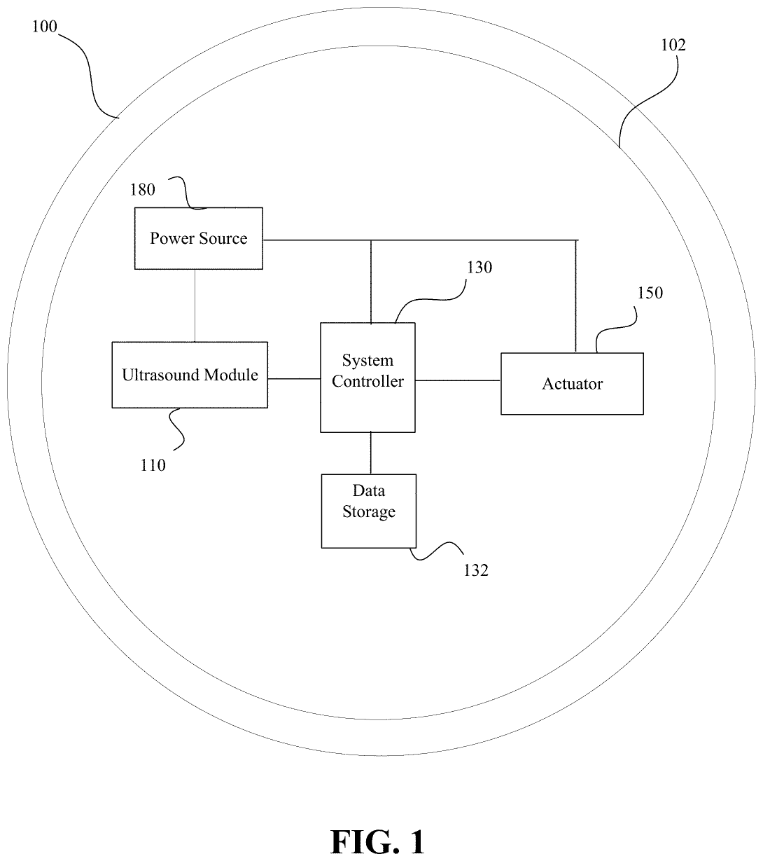

FIGS. 1-9 and 13 illustrate different embodiments according to the invention that include a system controller 130 connected to a timing circuit 140 and an ultrasound module (collectively referred to as 110) that are on a contact lens 100. The ultrasound module 110 may take a variety of forms including distinct transmit and receive transducers or a shared transmit/receive transducer. Depending on a particular implementation, there may be multiple ultrasound modules 110 present on the contact lens to facilitate particular functionality for the ophthalmic lens or alternatively multiple transducers connected to one or more ultrasound modules. Many of the figures include an actuator 150 as part of the system with the actuator 150 being representative of, for example, lens accommodation components, data collection components, data monitoring components, and/or functional components such as an alarm.

The system controller 130 in at least one embodiment uses at least one predetermined threshold or template for interpreting the output of the ultrasound module 110. In another embodiment, the system controller 130 makes use of at least one template (or pattern) to which a series of outputs of the ultrasound module 110 are compared against to determine whether the template has been satisfied, for example, based on a match to the pattern and/or a threshold being met, exceeded or less than resulting in the template being satisfied. In at least one embodiment, the template includes only at least one threshold. In an alternative embodiment, both thresholds and patterns are used by the system controller 130 to interpret a received series of sound pressure waves. In at least one embodiment as illustrated in FIG. 1, the system controller 130 is in electrical communication with a data storage 132 that stores the threshold(s) and/or template(s). In at least one embodiment, a plurality of templates includes any combination of patterns and thresholds. Examples of data storage 132 include memory such as persistent or non-volatile memory, volatile memory, and buffer memory, a register(s), a cache(s), programmable read-only memory (PROM), programmable erasable memory, magneto resistive random access memory (RAM), ferro-electric RAM, flash memory, and polymer thin film ferroelectric memory. In an alternative embodiment, the output(s) of the ultrasound module 110 to the system controller 130 is converted by the system controller 130 into data for control of the actuator 150. In an alternative embodiment, the system controller 130 interprets the output of the ultrasound module 110 using a predefined protocol.

FIG. 1 illustrates a system on a contact lens 100 having an electro-active region 102 with an ultrasound module 110, a system controller 130, an actuator 150, and a power source 180. In at least one further embodiment, the electro-active region 102 includes an electronics ring around the contact lens 100 on which the electronics are located. The ultrasound module 110 in at least one embodiment has two-way communication with the system controller 130. The actuator 150 receives an output from the system controller 130. In at least one alternative embodiment, the actuator 150 is omitted from one or more of the illustrated embodiments in this disclosure.

The actuator 150 may include any suitable device for implementing a specific function based upon a received command signal from the system controller 130. For example, if a set of data samples matches a template, the system controller 130 may enable the actuator 150 to change focus of the contact lens, provide an alert to the wearer via a light (or light array) to pulse a light or cause a physical wave to pulsate into the wearer's retina (or alternatively across the lens), or to log data regarding the state of the wearer. Further examples of the actuator 150 acting as an alert mechanism includes an electrical device; a mechanical device including, for example, piezoelectric devices, transducers, vibrational devices, chemical release devices with examples including the release of chemicals to cause an itching, irritation or burning sensation, and acoustic devices; a transducer providing optic zone modification of an optic zone of the contact lens such as modifying the focus and/or percentage of light transmission through the lens; a magnetic device; an electromagnetic device; a thermal device; an optical coloration mechanism with or without liquid crystal, prisms, fiber optics, and/or light tubes to, for example, provide an optic modification and/or direct light towards the retina; an electrical device such as an electrical stimulator to provide a mild retinal stimulation or to stimulate at least one of a corneal surface and one or more sensory nerves of the cornea; or any combination thereof. In an alternative embodiment, the actuator 150 sends an alert to an external device using, for example, the ultrasound module 110. The actuator 150 receives a signal from the system controller 130 in addition to power from the power source 180 and produces some action based on the signal from the system controller 130. For example, if the output signal from the system controller 130 occurs during one operation state, then the actuator 150 may alert the wearer that a medical condition has arisen or the contact lens is ending/nearing its useful life and/defective. In an alternative embodiment, the actuator 150 delivers a pharmaceutical product to the wearer in response to an instruction from the system controller 130. In an alternative embodiment, the signal output by the system controller 130 during another operation state causes the actuator 150 to record the information in memory for later retrieval. In a still further alternative embodiment, the signal will cause the actuator to alarm and store information. In an alternative embodiment, the system controller 130 stores the data in the memory (e.g., data storage 132 in other embodiments) associated with the system controller 130 and does not use the actuator 150 for data storage and in at least one embodiment, the actuator 150 is omitted. As set forth above, the powered lens of the present invention may provide various functionality; accordingly, one or more actuators may be variously configured to implement the functionality.

FIG. 1 also illustrates a power source 180, which supplies power for numerous components in the system. The power may be supplied from a battery, energy harvester, or other suitable means as is known to one of ordinary skill in the art. Essentially, any type of power source 180 may be utilized to provide reliable power for all other components of the system. In an alternative embodiment, communication functionality is provided by an energy harvester that acts as the receiver for the time signal, for example, in an alternative embodiment, the energy harvester includes a photovoltaic cell (in at least a contact lens embodiment), a photodiode(s) (in at least a contact lens embodiment), and/or a radio frequency (RF) receiver, which receives both power and a time-base signal (or indication). In a further alternative embodiment, the energy harvester is an inductive charger, in which power is transferred in addition to data such as RFID. In one or more of these alternative embodiments, the time signal could be inherent in the harvested energy, for example N*60 Hz in inductive charging or lighting.

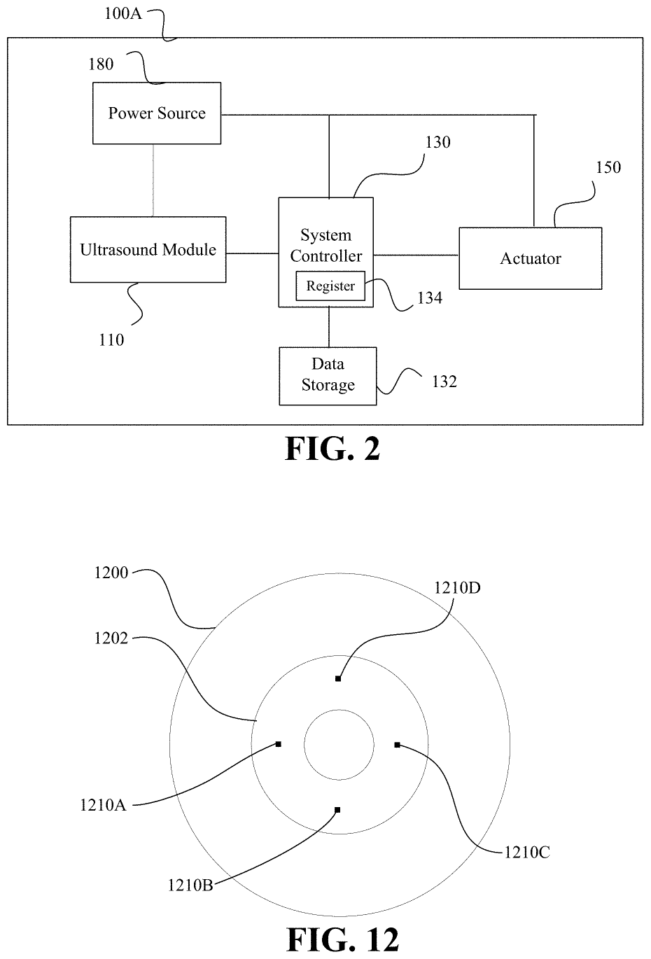

In at least one embodiment as illustrated in FIG. 2, the contact lens 100A includes the system controller 130 having a register 134 for storing data samples from the ultrasound module 110. In a further embodiment, there is an individual register for each ultrasound module 110 and/or a receiving transducer present on the contact lens 100A. The use of a register 134 in at least one embodiment allows for the comparison of data with prior data, a threshold, a preset value, a calibrated value, a target processing value, or a template with or without a mask. In an alternative embodiment, other data storage is used instead of a register(s). In an alternative embodiment, the register 134 is part of the data storage 132.

Based on this disclosure, it should be appreciated that in addition to the presence of the ultrasound module 110 on the contact lens 100 that additional sensors may be included as part of the contact lens to monitor characteristics of the eye and/or the lens. In at least one embodiment, at least a portion of the actuator 150 is consolidated with the system controller 130.

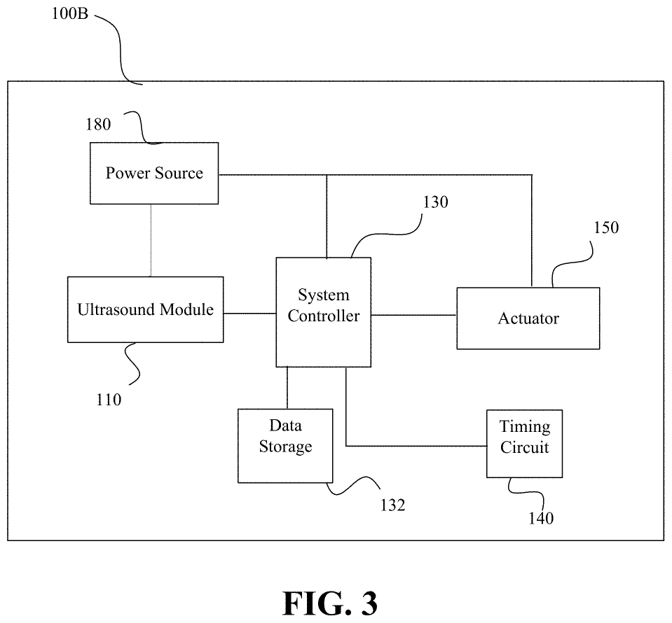

FIG. 3 illustrates another contact lens 100B that adds a timing circuit 140 to the system illustrated in FIG. 1. In an alternative embodiment, the timing circuit 140 may also be added to the embodiment illustrated in FIG. 2. The timing circuit 140 provides a clock function for operation of the contact lens. As illustrated the timing circuit 140 is connected to the system controller 130. In at least one embodiment, the timing circuit 140 drives the system controller 130 to send a signal to the ultrasound module 110 to perform a function based on a sampling time interval, which in at least one embodiment is variable based on the output from the ultrasound module 110 to the system controller 130. In an alternative embodiment, the timing circuit 140 is part of the system controller 130.

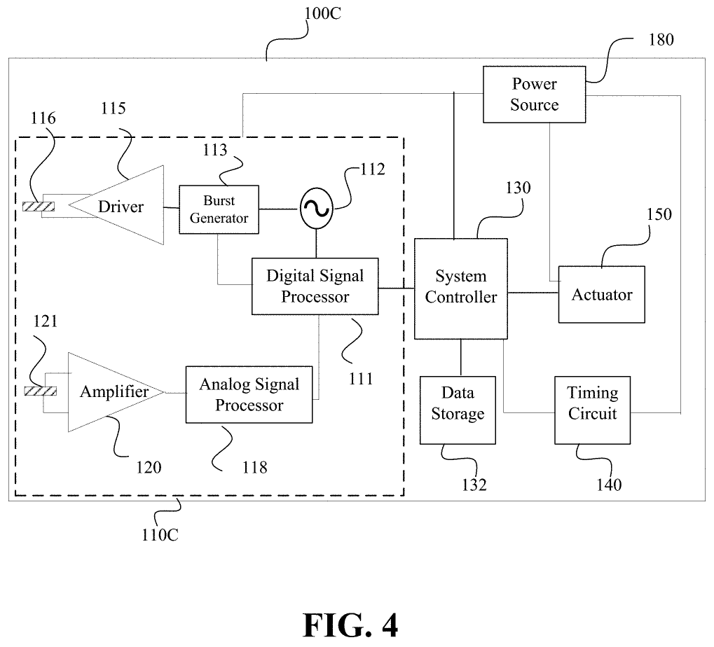

FIGS. 4-9 and 13 illustrate different ultrasound modules that illustrate different transmit paths and receive paths examples that facilitate transmitting and receiving sound pressure waves from one or more transducers 116, 121 that start or end with a processor 111 and/or the system controller 130 depending on the example embodiment.

FIG. 4 illustrates a contact lens 100C that includes an ultrasound module 110C having distinct transmit and receive sides to the ultrasound module 110C. The illustrated ultrasound module 110C includes a digital signal processor 111, an oscillator 112, a burst generator 113, a transmit driver 115, a transmit ultrasound transducer 116, an analog signal processor 118, a receive amplifier 120, and a receive ultrasound transducer 121. In at least one embodiment, the burst generator 113 produces a series of l′s and 0′s to facilitate communication with another lens and/or an external device. In at least one embodiment, the burst generator 113 incorporates a unique identifier for the contact lens based on the amplitude, the frequency, the length, and/or the code modulation of the signal. In a further embodiment, the unique identifier is provided by the system controller 130, the digital signal processor 111, the oscillator 112, and/or the burst generator 113. A similar use of an unique identifier may be used with other embodiments in this disclosure. In at least one alternative embodiment for the ultrasound module 110C, the digital signal processor 111 is combined with the system controller 130. In another alternative embodiment, the analog signal processor 118 is combined with the digital signal processor 111 and/or replaced with an analog-to-digital convertor as illustrated in a later figure. These two alternative embodiments may be combined to provide a further alternative embodiment.

The digital signal processor 111 receives a control signal from the system controller 130. In at least one embodiment, the digital signal processor 111 includes a resettable counter and a time-to-digital convertor and transmit/receive sequencing controls. The oscillator 112 in at least one embodiment is a switched oscillator. In at least one embodiment, the frequency of the oscillator 112 is programmable through a preset oscillator value, the system controller 130 or external interface. The frequency can be tuned using a reference oscillator and an external interface. In at least one further embodiment, the frequency is set or tuned to a value that minimizes transmit and receive electrical power and allows the transmit ultrasound transducer 116 to produce a pressure sound wave that will have maximum amplitude at the receiver input. In a more particular embodiment, the oscillator 112 is a programmable frequency oscillator such as a current starved ring oscillator where the current and the capacitance control the oscillation frequency where the frequency can be altered by changing the current supplied to the oscillator. In at least one embodiment, the wavelength of the sound pressure wave is tuned based on the dimensions of the transducer used. In a further embodiment, the oscillator 112 varies over time for optimal transmission characteristics. In a still further embodiment, the frequency is calibrated using a reference frequency provided through an external interface and an automatic frequency control (AFC) circuit. The frequency is preset with the AFC tuning it. The frequency can be directly set through the serial interface, which is accessed through the external communications link.

In an embodiment where the time of flight is used, the counter in the digital signal processor 111 begins to count pulses output from the oscillator 112. The burst generator 113 gates the oscillator signal for a fixed amount of time defined as the burst length. In at least one embodiment, the burst length is programmable or determined by static timing relationships within the burst generator 113.

The output voltage of the burst generator 113 may be level shifted to the appropriate value for the transmit driver 115 and the transmit ultrasound transducer 116. An example of the transmit ultrasound transducer 116 is a piezoelectric device which converts applied burst voltage to a sound pressure burst. In a further embodiment, the transmit ultrasound transducer 116 is made of any piezoelectric material that is compatible with the power source and the physical properties of the contact lens. The sound pressure wave produced by the transmit ultrasound transducer 116 propagates from the contact lens 100 into the field of view. The speed of sound in air typically is 343 meters/second, so in an embodiment that measures time of flight, then the distance to the object can be measured by dividing the travel time between the propagation of the sound pressure wave and receipt of the reflected sound pressure wave by the receive ultrasound transducer 121.

The receive amplifier 120 and the analog signal processor 118 in at least one embodiment are turned on with the oscillator 112 or turned on after a predetermined delay after the oscillator 112 is started. When there is a predetermined delay, power for contact lens operation may be lowered during the period of delay. In an embodiment where the receive amplifier 120 and the analog signal processor 118 are started with the oscillator 112, the receive amplifier 120 will receive an output from the receive ultrasound transducer 121 proximate to when the sound pressure wave is output by the transmit ultrasound transducer 116. This output from the receive ultrasound transducer 121 may be used to reset the counter in the digital signal processor 111. In a further embodiment, the detection of the transmit sound pressure wave may be used as an indicator that a true transmit signal has been generated.

A sound pressure wave received by the receive ultrasound transducer 121 will produce a voltage signal with a frequency and burst length properties related to the transmitted sound pressure wave. The voltage signal is amplified by the receive amplifier 120 before being sent to the analog signal processor 118, which in an alternative embodiment to embodiments having the receive amplifier 120 and the signal processor 118 are combined into a signal processor. The analog signal processor 118 may include frequency selective filtering, envelope detection, integration, level comparison and/or analog-to-digital conversion. Based on this disclosure, it should be appreciated that these functions may be separated into individual blocks with some examples being illustrated in later figures. The analog signal processor 118 produces a received signal that represents the received sound pressure wave at the receive ultrasound transducer 121, which in implementation will have a slight delay. The received signal is passed from the analog signal processor 118 to the digital signal processor 111. When transmission time is used, the digital signal processor 111 will stop the counter that is counting pulses from the oscillator 112 when the received signal is received. In other embodiments, the digital signal processor 111 interprets the received signal for a message from, for example, the other contact lens or an external device. The resulting output from the digital signal processor 111 is provided to the system controller 130.

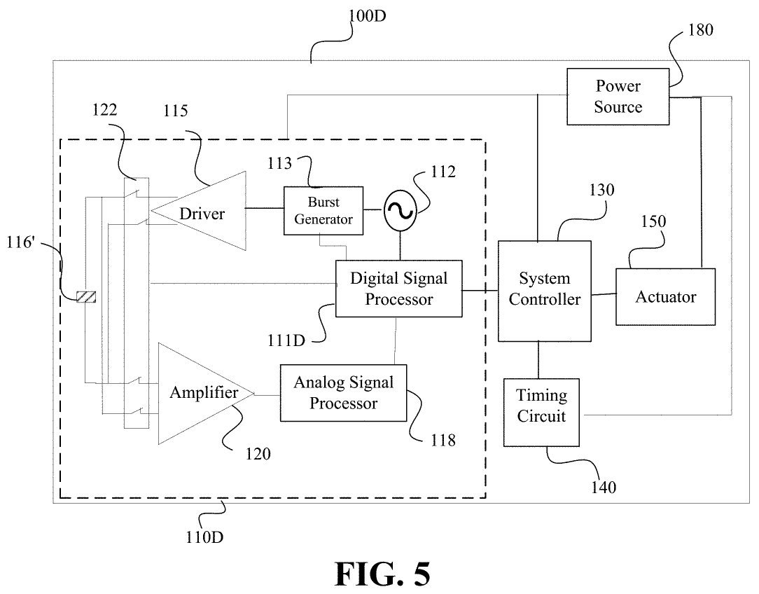

FIG. 5 illustrates a contact lens 100D with an ultrasound module 110D. The illustrated ultrasound module 110D includes one ultrasound transducer 116′ that is shared by the transmit and receive sides. The single ultrasound transducer 116′ is multiplexed between transmit and receive operation through use of a switch 122. The digital signal processor 111D uses the output of the burst generator 113 to switch the transducer 116′ to transmit mode by connecting the transmit driver 115 to the transducer 116′. When the burst is completed, the digital signal processor 111D switches the switch 122 to the receive mode by connecting the receive amplifier 120 to the transducer 116′. One advantage to this configuration is that the transducer area is reduced from two transducers to one transducer, but a drawback to this configuration is that a short time of flight may not be detected or if the ultrasound module 110D is being used for communication, then a received communication may be missed during a transmission or vice versa. As with the previous embodiment, a delay may be imposed after transmission before the receive amplifier 120 is powered. The remaining components of the illustrated embodiment remain the same from the prior embodiment.

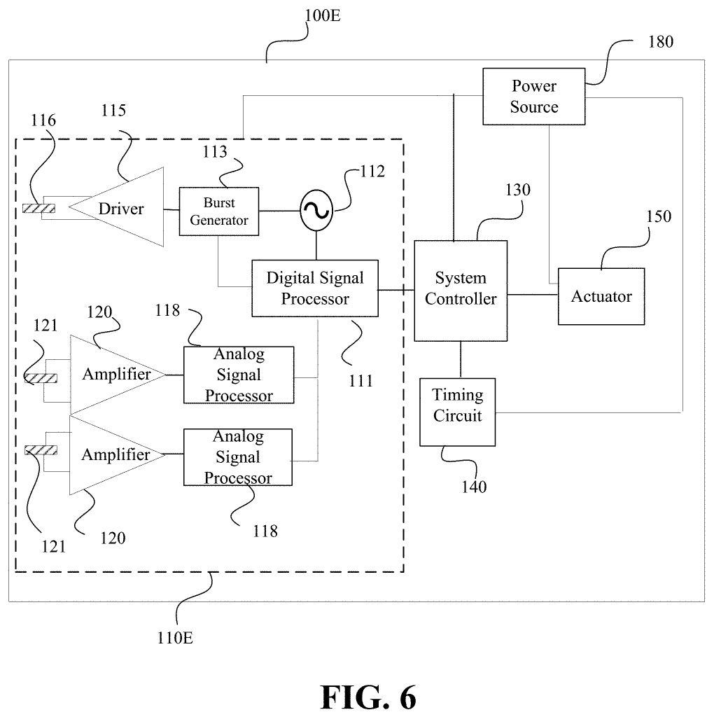

FIG. 6 illustrates a contact lens 100E where the receive side of the ultrasound module 110E includes two receive paths, which may be implemented in the other embodiments. One advantage to this configuration is that the transducers could be configured for different sound frequencies to match the frequency of the transmit path of the same contact lens and the second receive path to match the frequency of the transmit path of the other contact lens. A similar approach may be adopted in the other embodiments where the receive transducer matches the frequency of the transmit transducer of the other contact lens. Each of the receive paths include a receive ultrasound transducer 121 electrically connected to a receive amplifier 120, which is electrically connected to an analog signal processor 118. The analog signal processors 118 are electrically connected to the digital signal processor 111. In a further embodiment, a third receive path could be added to have a transducer 121 tuned to the frequency of an external device.

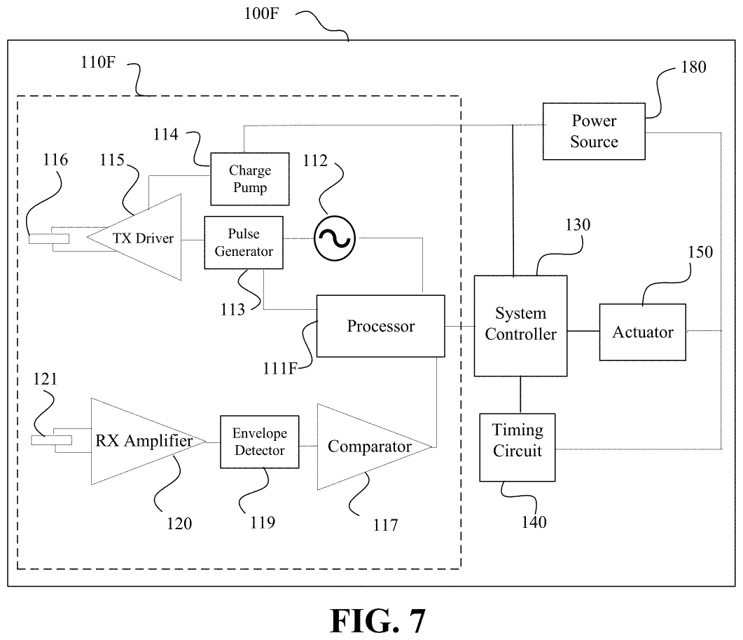

FIG. 7 illustrates a contact lens 100F with an ultrasound module 110F. The illustrated ultrasound module 110F includes a processor 111F, the oscillator 112, the pulse generator 113, a charge pump 114, the transmit driver 115, the transmit ultrasound transducer 116, a comparator 117, an envelope detector 119, the receive amplifier 120, and the receive ultrasound transducer 121. The charge pump 114 is electrically connected to the power source 180 and to the transmit driver 115, which provides a voltage to the transmit ultrasound transducer 116 to create the sound pressure wave to be emitted by the transducer 116. In at least one embodiment, the transmit driver 115 includes an inverter or an H-bridge, and in further embodiments includes an output driver circuit. In at least one embodiment, the charge pump 114 increases the voltage through the relationship between charge and capacitance with voltage by increasing the charge on a capacitance component(s) (e.g., a capacitor). The voltage output from the charge pump 114, in at least one embodiment, is used as the supply voltage to the transmit driver 115. The transmit driver 115 switches between the output of the charge pump 114 and ground in an alternating fashion in response to the input from the pulse generator 113 to produce an alternating voltage. The alternating voltage is applied by the driver 115 to polarize the material of the transducer 116 in one direction and then the other direction to create a mechanical stress causing the material to be displaced in a specific direction (i.e. the direction the transducer is facing). The displacement of the transducer material coupled with the shape and the size of the transducer produce the sound pressure wave. Thus, the larger the applied voltage is to the transducer, the larger the stress and thus the larger the displacement and associated sound pressure wave.

The charge pump 114 is also electrically connected to the processor 111F, which controls operation of the charge pump 114 in at least one embodiment to minimize power consumption by the system by, for example, turning off the oscillator 112, the pulse generator 113, and/or the charge pump 114 at times when the ultrasound module 110F does not need to propagate a sound pressure wave. The envelope detector 119 turns the high-frequency output of the receive ultrasound transducer 121 into a new signal that provides an envelope signal representative of the original output signal to be provided to the comparator 117. This illustrated embodiment has the advantage of simplifying the analysis of the output of the receive ultrasound transducer 121 to determine if a particular threshold has been met for the contact lens 100F to perform a function. The comparator 117 provides an output to the processor 111F, which is in electrical communication with the system controller 130.

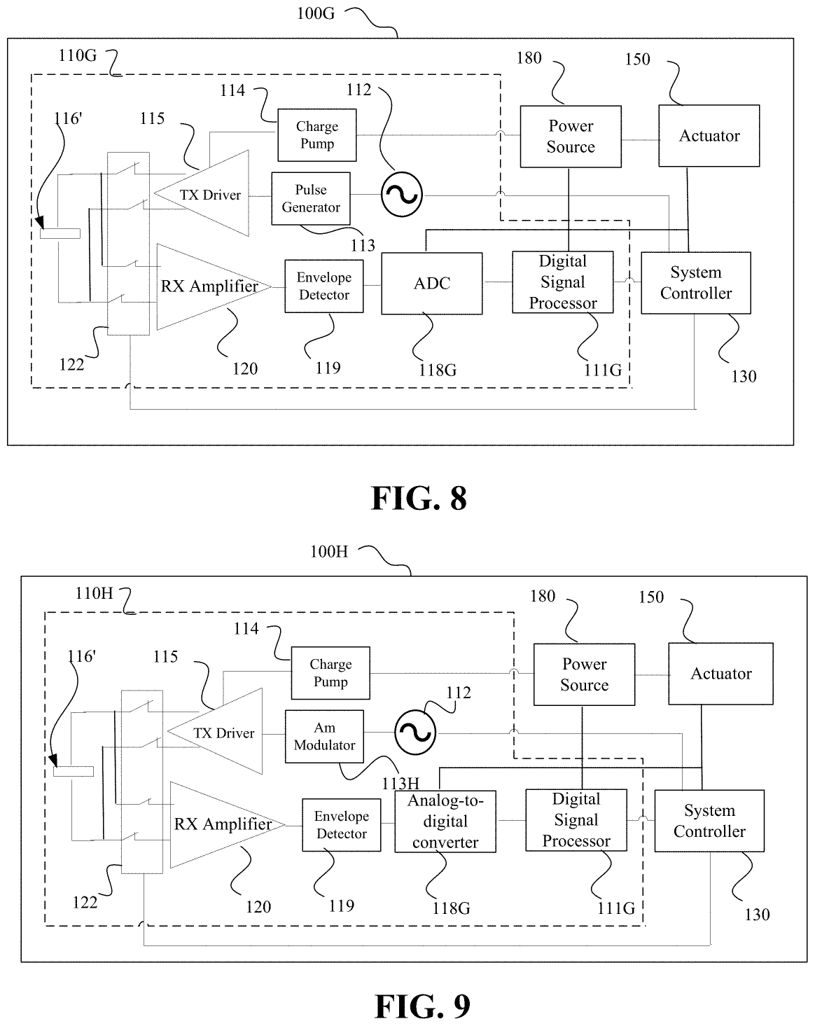

FIG. 8 illustrates a contact lens 100G with an ultrasound module 110G. The illustrated ultrasound module 110G includes a digital signal processor 111G, the oscillator 112, the pulse generator 113, the charge pump 114, the transmit driver 115, the transmit/receive ultrasound transducer 116′, an analog-to-digital converter (ADC) 118G, an envelope detector 119, the receive amplifier 120, and the switch 122. The ADC 118G converts the output from the envelope detector 119 into a digital signal for the digital signal processor 111G.

FIG. 9 illustrates a contact lens 100H with an ultrasound module 110H. The illustrated ultrasound module 110H includes a digital signal processor 111G, the oscillator 112, an amplitude modulation (AM) modulator 113H, the charge pump 114, the transmit driver 115 such as a transmit amplifier, the transmit/receive ultrasound transducer 116′, an analog-to-digital converter (ADC) 118G, an envelope detector 119, the receive amplifier 120, and the switch 122. In the illustrated embodiment, the charge pump 114, the AM modulator 113H and transmit driver 115 act as the level shifter and the burst generator. The AM modulator 113H in this embodiment is controlled by the digital signal processor 111G. The circuit works where the oscillator signal is provided to the AM modulator 113H, which in at least one embodiment is an AND gate, and the digital signal processor 111G provides a second clock at a frequency much lower than the oscillator frequency. The output of the circuit is then a sequence of pulses that occur during the positive cycle of the lower frequency. The transmit driver 115 has the appropriate gain to output the modulated signal at the charge pump voltage thus providing level shifting.

Based on the disclosure connected to FIGS. 7-9, one of ordinary skill in the art should appreciate that the different ultrasound module configurations and transducer/switch configurations may be interchanged and mixed together in different combinations.

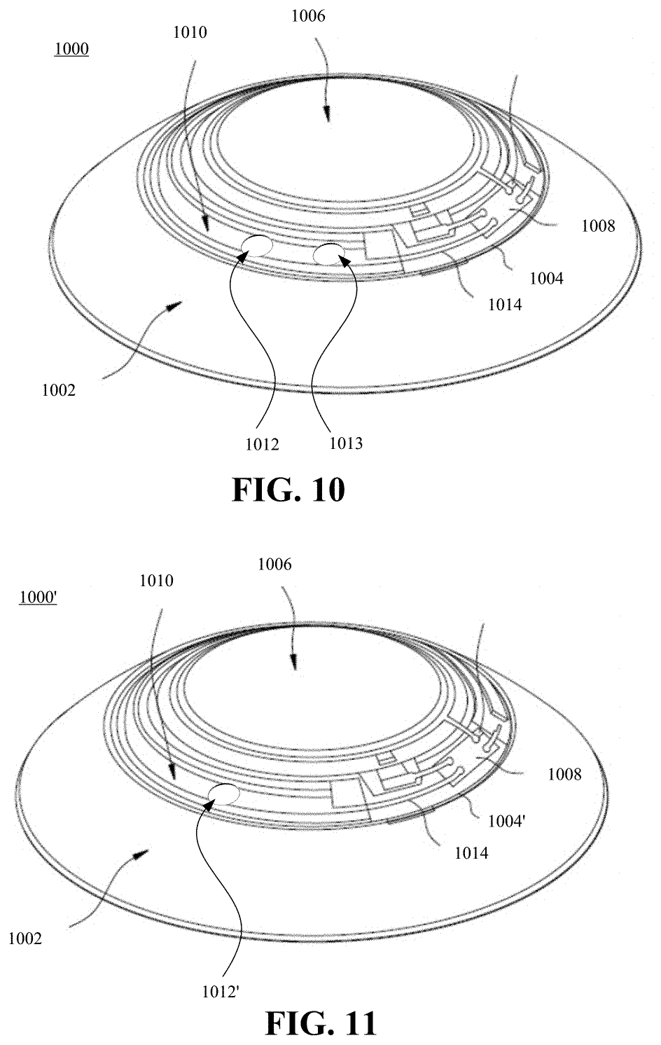

FIG. 10 illustrates a contact lens 1000 with an electronic insert 1004 having an ultrasound module. The contact lens 1000 includes a soft plastic portion 1002 which houses the electronic insert 1004, which in at least one embodiment is an electronics ring around a lens 1006. This electronic insert 1004 includes the lens 1006 which is activated by the electronics, for example focusing near or far depending on activation (or accommodation level). In at least one embodiment, the electronic insert 1004 omits the adjustability of the lens 1006. Integrated circuit 1008 mounts onto the electronic insert 1004 and connects to batteries (or power source) 1010, lens 1006, and other components as necessary for the system.

In at least one embodiment, a transmit ultrasound transducer 1012 and a receive ultrasound transducer 1013 are present in the ultrasound module. In at least one embodiment, the integrated circuit 1008 includes a transmit ultrasound transducer 1012 and a receive ultrasound transducer 1013 with the associated signal path circuits. The transducers 1012, 1013 face outward through the lens insert and away from the eye (i.e., front-facing), and are thus able to send and receive sound pressure waves. In at least one embodiment, the transducers 1012, 1013 are fabricated separately from the other circuit components in the electronic insert 1004 including the integrated circuit 1008. In this embodiment, the transducers 1012, 1013 may also be implemented as separate devices mounted on the electronic insert 1004 and connected with wiring traces 1014. Alternatively, the transducers 1012, 1013 may be implemented as part of the integrated circuit 1008 (not shown). Based on this disclosure one of ordinary skill in the art should appreciate that transducers 1012, 1013 may be augmented by the other sensors.

FIG. 11 illustrates another contact lens 1000′ with an electronic insert 1004′ having an ultrasound module. The contact lens 1000′ includes a soft plastic portion 1002 which houses the electronic insert 1004′. This electronic insert 1004′ includes a lens 1006 which is activated by the electronics, for example focusing near or far depending on activation (or accommodation level). In at least one embodiment, the electronic insert 1004′ omits the adjustability of the lens 1006. Integrated circuit 1008 mounts onto the electric insert 1004′ and connects to batteries (or power source) 1010, lens 1006, and other components as necessary for the system. The ultrasound module includes a transmit/receive ultrasound transducer 1012′ with the associated signal path circuits. The transducer 1012′ faces outward through the lens insert and away from the eye, and is thus able to send and receive sound pressure waves. As discussed above, the transducer 1012′ may be fabricated separately from the other electronic components prior to mounting on the electronic insert 1004 or alternatively implemented on the integrated circuit 1008 (not shown). The transducer 1012′ may also be implemented as a separate device mounted on the electronic insert 1004′ and connected with wiring traces 1014. Based on this disclosure one of ordinary skill in the art should appreciate that transducer 1012′ may be augmented by the other sensors.

In a further embodiment to the embodiments illustrated in FIGS. 10 and 11, the integrated circuit 1008, the power source 1010 and the transducers 1012, 1012′, 1013 are present in an area of the contact lens contained in an overmold, which is a material (such as plastic or other protective material) encapsulating the electronic insert 1004. In at least one further embodiment, the overmold encapsulates the ultrasound module(s).

In at least one embodiment, the electronics ring of FIGS. 10 and 11 includes an upper surface that is parallel with an imaginary plane on which the contact lens would rest. In at least one embodiment, the ultrasound transducer 1012, 1012′, and 1013 are angled relative to the electronics ring and that plane. Example ranges of the relative angle include 0° to 90°, 0° to 90° including either or both endpoints, 15° to 30°, and 15° to 30° including either or both endpoints. The 0° would be flat to the electronics ring top surface while 90° would be at a right angle to the electronics ring top surface. A benefit to having the transducer angled relative to the electronics ring is to better aim the outputted sound pressure wave towards the nose of the wearer.

In at least one embodiment as illustrated in FIG. 12 (omits the other components to facilitate presentation clarity), there are a plurality of ultrasound modules 1210A-1210D spaced around the contact lens 1202 on the eye 1200 to increase the fidelity of the communication link between the contact lenses through the nose. Although four ultrasound modules 1210A-1210D are illustrated, it should be appreciated based on this disclosure that a variety of numbers of ultrasound modules may be used with example numbers of ultrasound modules being any number between 2-8, a plurality of ultrasound modules, and at least one ultrasound module. The illustrated ultrasound modules 1201A-1210D are evenly spaced around the periphery of the contact lens 1202 where evenly spaced includes equal distance between the ultrasound modules (i.e., the same distance between neighboring ultrasound modules) and/or balanced about a diameter drawn through the contact lens 1202.

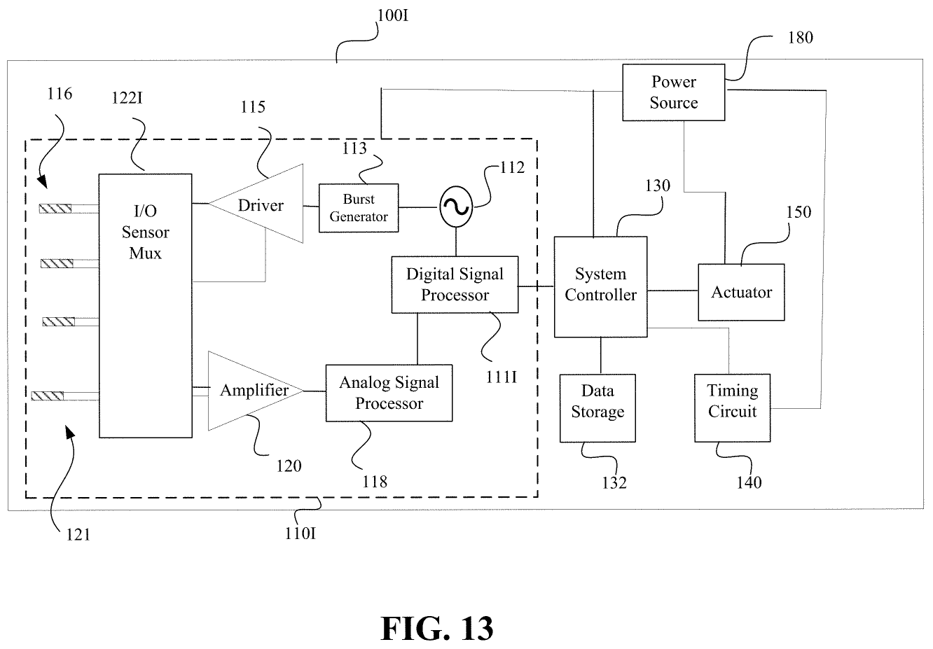

In at least one embodiment, the system controller deactivates the transmission components of the ultrasound module when the respective contact lens is not transmitting. In a further embodiment, the illustrated ultrasound modules are replaced by transducers that are multiplexed together as illustrated in FIG. 13. In a further embodiment for contact lenses that have a plurality of ultrasound modules or at least a plurality of transmit/receive/transceiver transducers, the method includes having the system controller determine which ultrasound module/transducer provides the best response. The system controller selects the ultrasound module/transducer that produces a highest output response to received sound pressure waves. The system controller will deactivate the ultrasound module(s)/transducer(s) that were not selected (i.e., provided a lower signal strength). One benefit to this method is that as the contact lens rotates on the eye, the system controller can change the used ultrasound module/transducer to avoid any ultrasound module/transducer covered by an eyelid and/or for intra-contact communication.

In an alternative embodiment illustrated in FIG. 13, the contact lens 1001 has one ultrasound module 1101 having a plurality of transducers 116, 121 and an I/O sensor multiplexer (mux) 1221 attaching the transducers 116, 121 to the ultrasound module components discussed in the above embodiments. FIG. 13 illustrates the inclusion of the digital signal processor 1111, the oscillator 112, the burst generator 113, the driver 115, the amplifier 120, and the analog signal processor 118. In alternative embodiment, these ultrasound module components may be replaced by components from the other described ultrasound module embodiments including using just the transmit or receive paths of those embodiments. An advantage of this configuration is that it reduces the power requirements and weight considerations by eliminating duplicative components and allowing the ultrasound module to drive multiple transmit transducers and to receive analog signals from multiple receive transducers. In at least one embodiment, the transmit transducers and the receive transducers are distributed about the contact lens as discussed above in connection with FIG. 12. In a further embodiment, the transmit transducers and the receive transducers are grouped together in one area of the contact lens.

In at least one embodiment where the contact lens includes rotational stability features, then the number of ultrasound modules is one. The angle at which the transducer is relative to the electronics ring may be more severe such that a perpendicular line drawn from the transducer would intersect with the bridge (or just below the bridge) of most wearers of the intended population for the contact lens.

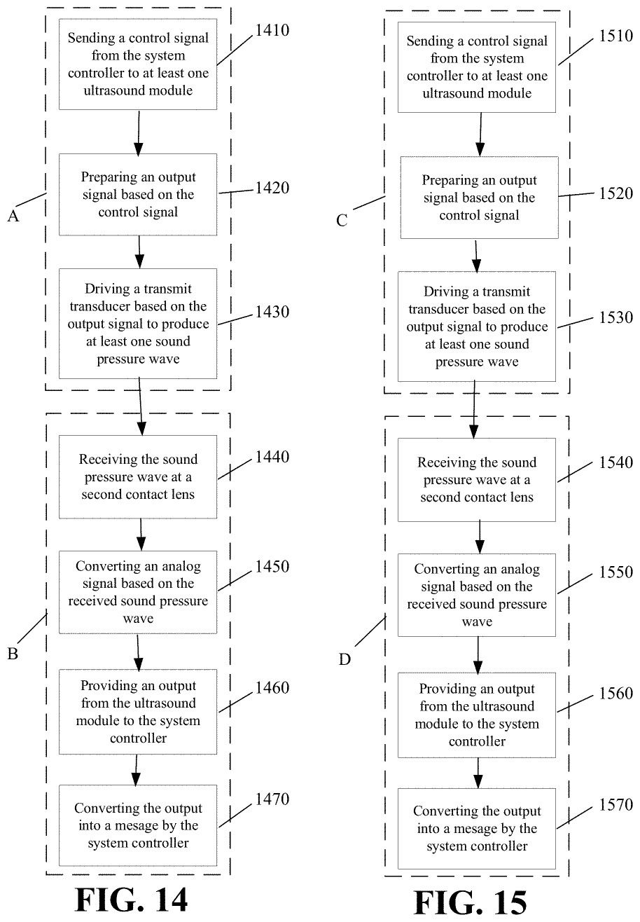

FIG. 14 illustrates a method that may be used with more than one of the above-described system embodiments. The illustrated method provides an example of how communication may be facilitated between two contact lenses, a first contact lens and a second contact lens, across and/or through a nose of the person wearing (or using) the contact lenses. The nose provides a medium in which the sound pressure waves produced by at least one transducer on one contact lens are scattered and in effect have its path bent towards the other contact lens. FIG. 14 is divided into two groups of steps A and B to indicate which lens performs the respective steps (i.e, the first contact lens A and the second contact lens B). In at least one embodiment, similar methods can be used for implanted intraocular lenses during use.

The system controller on the first contact lens sends a control signal that embodies a message intended for the second contact lens to the ultrasound module(s), 1410. The message may include sensor data, a request for sensor data, a request for confirmation of data interpretation (e.g., direction of focus and/or contact lens orientation), data interpretation, an instruction to perform a function such as with the actuator and/or a predefined function, etc. In at least one embodiment, the message is created by the system controller using a predetermined protocol for communication between the contact lenses. The ultrasound module prepares an output signal based on the control signal, 1420. In an alternative embodiment, the output signal preparation is omitted if the control signal is sufficient for driving the transducer, which may be a dedicated transmit transducer. The ultrasound module drives the transducer to produce at least one sound pressure wave based on the output signal, 1430.

The second contact lens receives the at least one partially scattered sound pressure wave from the first contact lens, 1440. The second contact lens uses its transducer, which in at least one embodiment is a dedicated receive transducer. When the contact lens(es) has a common transceiver transducer to transmit and receive, then in at least one embodiment the transceiver transducer is in a default position of receive mode. The ultrasound module converts an analog signal representing the sound pressure wave received by the transducer, 1450. The resulting output is provided by the ultrasound module to a system controller, 1460. The system controller converts the output into the message from the system controller on the first contact lens, 1470.

FIG. 15 illustrates a method for the second contact lens to respond to the first contact lens. FIG. 15 is divided into two groups of steps C and D to indicate which lens performs the respective steps (i.e, the second contact lens C and the first contact lens D).

The system controller on the second contact lens sends a control signal that embodies a message intended for the first contact lens to the ultrasound module(s), 1510. The message may include sensor data, a request for sensor data, a request for confirmation of data interpretation (e.g., direction of focus and/or contact lens orientation), data interpretation, an instruction to perform a function such as with the actuator, etc. The ultrasound module prepares an output signal based on the control signal, 1520. In an alternative embodiment, the output signal preparation is omitted if the control signal is sufficient for driving the transducer, which may be a dedicated transmit transducer. The ultrasound module drives the transducer to produce at least one sound pressure wave based on the output signal, 1530.

The first contact lens receives the at least one partially scattered sound pressure wave from the second contact lens, 1540. The first contact lens uses its transducer, which in at least one embodiment is a dedicated receive transducer. When the contact lens(es) has a common transceiver transducer to transmit and receive, then in at least one embodiment the transceiver transducer is in a default position of receive mode. The ultrasound module converts an analog signal representing received sound pressure wave received by the transducer, 1550. The resulting output is provided by the ultrasound module to a system controller, 1560. The system controller converts the output into the message from the system controller on the second contact lens, 1570. In a further embodiment, the first contact lens performs a function based on the received message such as change the activation level of the lens.

In an alternative embodiment to the methods illustrated in FIGS. 14 and 15, the system controller deactivates the transmission components of the ultrasound module when the respective contact lens is not transmitting.

In a further embodiment, the sound pressure waves produced by the first and second contact lenses are at different frequencies such as the first contact lens using a first frequency and the second contact lens using a second frequency. The ultrasound module in at least one embodiment then is tuned for the frequency of the output sound pressure wave produced by the other contact lens. An advantage of this is that it improves each receiver's capability of correctly detecting the desired signal. By using separate frequencies, frequency selective techniques (such as mixing and envelope detection) can reject noise or undesired transmit signals that could be produced by the physical geometry and properties of the communication channel through scattering on the nose.

In a further embodiment, the message sent is a wake-up message to activate the ultrasound module(s) on the second contact lens. In at least one implementation, the second contact lens will activate for short periods of time at a predetermined sampling rate to detect the wake-up message being broadcasted by the first contact lens at a predetermined broadcast rate. In at least one embodiment the predetermined sampling rate and the predetermined broadcast rate are at different frequencies where one rate is faster than the other to allow for the sampling and the broadcasting to intersect eventually. Alternatively, the short period of time is of sufficient length to cover the frequency period for the predetermined broadcast rate or slightly longer to address a situation where the clock frequencies of the two contact lenses may be different. A wake-up message may be used for initial activation of the second contact lens along with reactivation of the second contact lens, for example, when the contact lenses are in a slower operational or sleep state when the wearer is asleep or resting or alternatively has set the operational mode to a state in which communication between the contact lenses is not necessary. In a further embodiment, the wake-up message is sufficient strength and length to facilitate the second contact lens generating sufficient power to activate in response to the wake-up message such as the energy harvester being activated by the current generated by the receive transducer.

In a further embodiment for contact lenses that have a plurality of ultrasound modules or at least transmit/receive/transceiver transducers, the method includes having the system controller determine which ultrasound module/transducer provides the best communication path. The system controller selects the ultrasound module/transducer that produces a highest output response to the sound pressure wave produced by the other contact lens. This measurement may be made during performance of the above-described communication methods or a communication consisting of pinging back and forth between the contact lens. The pinging communication may occur on a predetermined schedule or at predetermined intervals possibly even as part of a clock synchronization between the contact lenses. The system controller will deactivate the ultrasound module(s)/transducer(s) that were not selected (i.e., provided a lower signal strength). One benefit to this method is that as the contact lens rotates on the eye, the system controller can change the used ultrasound module/transducer for intra-contact communication.

One approach to facilitate the communication between the contact lenses is to implement automatic frequency control for the communication channel. In at least one embodiment, the timing circuit on one contact lens would be the master. The clock synchronization in at least one embodiment will lead the electronics to be biased towards a lens pair to have one be a master. In a further embodiment, the selection of the master contact lens is made post-manufacturing via a software download to the lenses and/or settings change. This approach also could be used to facilitate the dual frequency approach discussed in this disclosure.

Although shown and described in what is believed to be the most practical embodiments, it is apparent that departures from specific designs and methods described and shown will suggest themselves to those skilled in the art and may be used without departing from the spirit and scope of the invention. The present invention is not restricted to the particular constructions described and illustrated, but should be constructed to cohere with all modifications that may fall within the scope of the appended claims.

What is claimed is:

1. An ophthalmic lens system comprising:
a first ophthalmic lens;
a second ophthalmic lens; and
wherein each ophthalmic lens including
at least one ultrasound module in said ophthalmic lens, at least one of said at least one ultrasound module includes at least one transducer front-facing and orientated such that when a sound pressure wave is produced, the sound pressure wave travels outwardly from said ophthalmic lens,
a system controller in electrical communication with said at least one ultrasound module, said system controller configured to provide a control signal to said at least one ultrasound module where the control signal includes a message to be transmitted by said at least one ultrasound module, said system controller configured to receive an output from said at least one ultrasound module and to perform a function in response to a receive message embodied in the output, and
a timing circuit in electrical communication with said system controller, said timing circuit configured to produce a timing signal when said system controller is activated.

2. The ophthalmic lens systems according to claim 1, wherein said first ophthalmic lens is a first contact lens and said second ophthalmic lens is a second contact lens.

3. The ophthalmic lens systems according to claim 1, wherein said first ophthalmic lens is a first intraocular lens and said second ophthalmic lens is a second intraocular lens.

4. The ophthalmic lens system according to claim 1, wherein
said at least one ultrasound module on said first ophthalmic lens configured to produce the sound pressure wave at a first frequency,
said at least one ultrasound module on said second ophthalmic lens configured to produce the sound pressure wave at a second frequency,
said at least one ultrasound module on said second ophthalmic lens has a receive transducer tuned to sense the sound pressure wave at the first frequency, and
said at least one ultrasound module on said first ophthalmic lens has a receive transducer tuned to sense the sound pressure wave at the second frequency.

5. The ophthalmic lens system according to claim 4, wherein
said at least one ultrasound module on said first ophthalmic lens has a second receive transducer tuned to sense the sound pressure wave at the first frequency, and
said at least one ultrasound module on said second ophthalmic lens has a second receive transducer tuned to sense the sound pressure wave at the second frequency.

6. The ophthalmic lens system according to claim 1, wherein each ophthalmic lens includes a plurality of ultrasound modules evenly distributed around the perimeter of said ophthalmic lens.

7. The ophthalmic lens system according to claim 6, wherein on each lens,
said system controller configured to activate said ultrasound module that produces the strongest output in response to a sound pressure wave produced by said other ophthalmic lens, and
said system controller configured to deactivate said at least one other ultrasound module on said ophthalmic lens.

8. The ophthalmic lens system according to claim 1, wherein
said at least one transducer includes a transmit transducer and a receive transducer, and each ultrasound module includes
a processor in electrical communication with said system controller;
a transmit path having
an oscillator in electrical communication with said processor,
a burst generator in electrical communication with said oscillator and said processor,
a transmit driver in electrical communication with said burst generator configured to receive a burst signal from said burst generator,
said transmit transducer in electrical communication with said transmit driver; and
at least one receive path having
said receive transducer,
a receive amplifier in electrical communication with said receive transducer and configured to amplify an output of said receive transducer, and
an analog signal processor in communication with said receive amplifier and said processor, and
wherein said processor configured to control whether said transmit path and said at least one receive path are activated.

9. The ophthalmic lens system according to claim 8, wherein each ultrasound module includes two receive paths and said at least one transducer including another receive transducer,
said two receive paths having said receive transducer tuned to different frequencies.

10. The ophthalmic lens system according to claim 1, wherein
said at least one transducer includes a plurality of transducers, and
said ultrasound module includes
a processor in electrical communication with said system controller;
a multiplexer in electrical communication with said plurality of transducers;
a transmit path having
an oscillator in electrical communication with said processor,
a burst generator in electrical communication with said oscillator and said processor,
a transmit driver in electrical communication with said burst generator configured to receive a burst signal from said burst generator and said multiplexer; and
at least one receive path having
a receive amplifier in electrical communication with said multiplexer and configured to amplify an output of said receive transducer, and
an analog signal processor in communication with said receive amplifier and said processor, and
wherein said processor configured to control whether said transmit path and said at least one receive path are activated, and
said multiplexer provides selective communication between at least one transducer with said transmit path or said at least one receive path.

11. The ophthalmic lens system according to claim 1, wherein
said at least one transducer is one transducer, and
each ultrasound module includes
a processor in electrical communication with said system controller;
said transducer;
a switch in electrical communication with said processor;
a transmit path having
an oscillator in electrical communication with said processor,
a burst generator in electrical communication with said oscillator and said processor,
a transmit driver in electrical communication with said burst generator configured to receive a burst signal from said burst generator, said transmit driver drives said transducer when connected through said switch; and
at least one receive path having
a receive amplifier in electrical communication with said transducer through said switch and configured to amplify an output of said transducer, and
an analog signal processor in communication with said receive amplifier and said processor, and
wherein said processor configured to control whether said transmit path and said at least one receive path are activated based on an operation mode of said ultrasound module between transmit and receive, and
said processor configured to control said switch and the operation mode.

12. The ophthalmic lens system according to claim 1, wherein
each ophthalmic lens includes a power source in electrical communication with said system controller and said at least one ultrasound module;
said at least one transducer includes a transmit transducer and a receive transducer; and
each ultrasound module includes
a processor in electrical communication with said system controller;
a transmit path having
an oscillator in electrical communication with said processor,
a pulse generator in electrical communication with said oscillator and said processor,
a charge pump in electrical communication with said power source,
a transmit driver in electrical communication with said pulse generator and said charge pump, said transmit driver configured to receive a signal from said pulse generator,
said transmit transducer in electrical communication with said transmit driver; and
at least one receive path having
said receive transducer,
a receive amplifier in electrical communication with said receive transducer and configured to amplify an output of said receive transducer, and
an envelope detector in electrical communication with said receive amplifier,
an analog signal processor in communication with said envelope detector and said processor, and
wherein said processor configured to control whether said transmit path and said at least one receive path are activated.

13. The ophthalmic lens system according to claim 1, wherein
each ophthalmic lens includes a power source in electrical communication with said system controller and said at least one ultrasound module;
said at least one transducer includes a transmit transducer and a receive transducer, and
each ultrasound module includes
a processor in electrical communication with said system controller;
a transmit path having
an oscillator in electrical communication with said processor,
an amplitude modulation modulator in electrical communication with said oscillator and said processor,
a charge pump in electrical communication with said power source,
a transmit driver in electrical communication with said amplitude modulation modulator and said charge pump, said transmit driver configured to receive a signal from said amplitude modulation modulator,
said transmit transducer in electrical communication with said transmit driver; and
at least one receive path having
said receive transducer,
a receive amplifier in electrical communication with said receive transducer and configured to amplify an output of said receive transducer, and
an envelope detector in electrical communication with said receive amplifier,
an analog signal processor in communication with said envelope detector and said processor, and
wherein said processor configured to control whether said transmit path and said at least one receive path are activated.

14. The ophthalmic lens system according to claim 1, wherein said at least one transducer is angled relative to an imaginary plane taken at a bottom edge of the said ophthalmic lens on which said at least one transducer is located.

15. A method for facilitating communication between a first ophthalmic lens and a second ophthalmic lens when being used by a person where each ophthalmic lens includes at least one ultrasound module in electrical communication with a system controller, the ultrasound modules having a forward facing transmit transducer, said method comprising:
sending a control signal from the system controller on the first ophthalmic lens to the ultrasound module on the first ophthalmic lens where the control signal embodies a message intended for the second ophthalmic lens;
preparing an output signal by the ultrasound module on the first ophthalmic lens based on the message;
driving the transmit transducer on the first ophthalmic lens based on the output signal to produce at least one sound pressure wave;
receiving with a transducer on the second ophthalmic lens at least one partially scattered sound pressure wave from the transducer on the first ophthalmic lens;
converting with the ultrasound module on the second ophthalmic lens an analog signal produced by the transducer on the second ophthalmic lens in response to the received sound pressure wave;
providing an output to the system controller on the second ophthalmic lens from the ultrasound module on the second ophthalmic lens; and
converting with the system controller on the second ophthalmic lens the output into the message from the system controller on the first ophthalmic lens, and
wherein a nose of the person using the ophthalmic lenses scatters the sound pressure wave produced by the first ophthalmic lens.

16. The method according to claim 15, further comprising:
sending a control signal from the system controller on the second ophthalmic lens to the ultrasound module on the second ophthalmic lens where the control signal embodies a message intended for the first ophthalmic lens;
preparing an output signal by the ultrasound module on the second ophthalmic lens based on the message intended for the first ophthalmic lens;
driving the transmit transducer on the second ophthalmic lens based on the output signal to produce at least one sound pressure wave;
receiving with a receive transducer on the first ophthalmic lens at least one partially scattered sound pressure wave from the transmit transducer on the second ophthalmic lens;
converting with the ultrasound module on the first ophthalmic lens an analog signal produced by the receive transducer on the first ophthalmic lens;
providing an output to the system controller on the first ophthalmic lens from the ultrasound module on the first ophthalmic lens; and
converting with the system controller on the first ophthalmic lens the output into the message from the system controller on the first ophthalmic lens, and
wherein a nose of the person wearing the ophthalmic lenses scatters the sound pressure wave produced by the second ophthalmic lens.

17. The method according to claim 16, wherein the sound pressure waves produced by the first and second ophthalmic lens are at different frequencies.

18. The method according to claim 17, wherein each ultrasound module includes the transducer tuned to the frequency of the output transducer of the other ophthalmic lens and a second receive transducer tuned to the frequency of the output transducer of its ophthalmic lens.

19. The method according to claim 15, wherein each ophthalmic lens includes a plurality of ultrasound modules evenly distributed around the periphery of the ophthalmic lens; and
the method further comprising:
selecting by the at least one system controller the ultrasound module on its ophthalmic lens that produces a highest output in response to the sound pressure wave produced by the other ophthalmic lens, and
deactivating by the at least one system controller the non-selected ultrasound modules.

20. The method according to claim 15, further comprising deactivating the transmission components of the ultrasound module when not transmitting.

21. The method according to claim 15, wherein the message sent by the system controller of the first ophthalmic lens uses a predefined protocol.

22. The method according to claim 15, wherein the message sent by the system controller of the first ophthalmic lens includes instructions for the second ophthalmic lens to perform a predefined function.

23. The method according to claim 15, wherein the message sent by the system controller of the first ophthalmic lens includes sensor readings from at least one sensor on the first ophthalmic lens.
